(19) United States
(12) Patent Application Publication
(10) Pub. No.: US 2026/0110415 A1
(43) Pub. Date: Apr. 23, 2026

(54) ATTACHMENT ASSEMBLY FOR A COVER LENS ON A HOUSING, LIGHTING DEVICE FOR A MOTOR VEHICLE, AND METHOD FOR REPLACING A COVER LENS

(71) Applicant: Hella GmbH & Co. KGaA, Lippstadt (DE)

(72) Inventor: Paul Friesen, Rheda-Wiedenbrück (DE)

(21) Appl. No.: 19/200,266

(22) Filed: May 6, 2025

(30) Foreign Application Priority Data
May 14, 2024 (DE) 102024113458.5

(51) Int. Cl. F21S 45/10; F21S 41/29

(52) U.S. Cl. CPC F21S 45/10; F21S 41/29

(57) ABSTRACT

An attachment assembly is provided for a cover lens on a housing. The cover lens is attached to the housing by a first adhesive bond with a circumferential adhesive bed. A second adhesive bond is formed with a circumferential adhesive bed between the cover lens and the housing.

### CROSS REFERENCE

This application claims priority to German Application No. 10 2024 113458.5, filed May 14, 2024, the entirety which is hereby incorporated by reference.

### FIELD OF THE INVENTION

The present invention relates to an attachment assembly for a cover lens on a housing, an associated lighting device for a motor vehicle, and a method for replacing the cover lens with an attachment assembly obtained with the invention.

### BACKGROUND OF THE INVENTION

Motor vehicle lighting devices have a cover lens normally made of plastic, which closes the housing for the lighting device where light is emitted. The cover lens is normally attached to the housing with an adhesive bond, which also seals the housing. One of the parts has a circumferential channel for this, in which the adhesive is placed to form an adhesive bed, and a collar is formed on the other part that extends into the adhesive bed.

The cover lens is normally not intended to be replaced in the prior art, or can only be replaced with great difficulty. This is because a permanent, two-component adhesive is normally used to obtain a durable bond that can withstand the conditions normally encountered when in use, in particular thermal conditions. Releasable adhesive such as hot melts require supplementary fasteners such as clamps, snap-in connections, or threaded fasteners. When replacing the cover lens, these supplementary fasteners are difficult to release, the adhesive must be heated, and cleaning the residual adhesive from the channels prior to inserting a new adhesive bed is difficult.

### BRIEF SUMMARY OF THE INVENTION

The object of the present invention is to propose a different attachment assembly for a cover lens on a housing that allows for the cover lens to be replaced.

In an example embodiment, the invention is based on a cover lens for a housing with a conventional attachment assembly, obtained with an adhesive bond that has a circumferential adhesive bed, and includes the technical teachings that the attachment assembly contains means for creating a second adhesive bond with a circumferential adhesive bed between the cover lens and the housing.

The fundamental idea of the invention is to consider replacement of the cover lens during the production process, and design the parts participating in the attachment assembly such that two functionally equivalent adhesive bonds with circumferential adhesive beds can be formed between them. A first adhesive bed is formed in the factory using a permanent adhesive with which the cover lens is initially attached to the housing. The second adhesive bond is formed when replacing the cover lens, i.e. after the first adhesive bond has been mechanically released. The means for forming the second adhesive bond include a circumferential channel for the adhesive bed on one of the parts, i.e. the cover lens or housing, and a collar on the other part that extends into the adhesive bed. The means for obtaining the second adhesive bond are preferably toward the inside the first adhesive bond, i.e. the first adhesive bond forms a seal against the operating environment.

The attachment assembly obtained with the invention advantageously allows for the cover lens to be replaced if necessary, e.g. due to damage thereto, or to be able to service or replace components within the housing.

The cover lens and/or housing have circumferential collars that are received in the adhesive beds to obtain the adhesive bonds. By way of example, the adhesive bed for the first adhesive bond is formed on the housing, and the cover lens then has a circumferential collar that extends into the adhesive bed, thus forming the joining surface for the first adhesive bond on the cover lens.

This attachment assembly obtained with the invention advantageously allows for the cover lens to be replaced if it becomes damaged, or if components in the housing need to be serviced or replaced.

In particular, the cover lens and/or housing have circumferential collars that are received in the adhesive beds to obtain the adhesive bonds. By way of example, the adhesive bed for the first adhesive bond is formed on the housing, and the cover lens has a circumferential collar that extends into the adhesive bed, thus forming the joining surface for the first adhesive bond on the cover lens.

In an advantageous embodiment, the cover lens or housing has an attachment section with two circumferential channels forming an outer and inner channel, with the adhesive bed for the first adhesive bond in the outer channel, and the adhesive bed for the second adhesive bond in the inner channel. The two channels are parallel to one another. Joining sections are formed on the other part, comprising circumferential collars that extend into the channels. The first adhesive bond is formed by the outer adhesive bed in the outer channel, into which the associated collar extends. The second adhesive bond between a cover lens and the housing can be formed by filling the inner channel with an adhesive to obtain an adhesive bed that receives its associated collar.

In another embodiment, the cover lens and housing each have an attachment section with a circumferential channel, forming an inner channel and an outer channel, with the adhesive bed for the first adhesive bond being placed in the outer channel, and the adhesive bed for the second adhesive bond being placed in the inner channel. The outer rim of the inner channel preferably forms a circumferential collar that extends into the outer channel and the adhesive bed therein to obtain the first adhesive bond. This results in a particularly compact attachment assembly, that requires very little space in the vehicle body when used for a lighting device for a motor vehicle.

These attachment sections advantageously have circumferential predetermined breaking points where the first adhesive bond can be released. The attachment sections can be mechanically separated at the predetermined breaking points, such that the attachment assembly is released, and the cover lens can be removed in order to replace it.

A seal, e.g. a foam rubber element, can be placed in the inner channel. This protects the inner channel from contaminants when releasing the first adhesive bond.

In an example embodiment, the invention also relates to a lighting device for a motor vehicle, in particular a headlamp, that comprises a cover lens and a housing which form an attachment assembly obtained with the invention according to any of the embodiments described above. The cover lens is normally made of a polycarbonate, and the first adhesive bond is formed by a permanent, two-component adhesive.

The attachment assembly obtained with the invention can also be used for sensors in motor vehicles, e.g. radar distancing sensors for detecting objects in a vehicle environment.

In an example embodiment, the invention also relates to a method for replacing the cover lens in an attachment assembly obtained with the invention, comprising at least the following steps: releasing the first adhesive bond (3) and removing the cover lens (1) that is to be replaced; inserting a circumferential adhesive bed (40); and placing a new cover lens (1b) on the housing (2), forming the second adhesive bond (4).

The first adhesive bond is released mechanically, irreversibly destroying it. The connecting sections on the cover lens and/or housing are preferably separated along the predetermined breaking points such that a clean and well-defined separating line is obtained. When inserting the adhesive bed for the second bond, the same type of adhesive can be used that was used for the first bond. After inserting the adhesive bed, the new cover lens is placed in substantially the same position as the previous cover lens on the housing, thus pressing a joining section in the form of a circumferential collar into the fresh adhesive bed. The second adhesive bond is obtained when the adhesive bed is cured. By way of example, metal clamps can be used to secure the parts to one another during the curing process.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a housing for an attachment assembly obtained according to an example embodiment of the invention.

FIG. 2 shows a first exemplary embodiment of the attachment assembly.

FIG. 3 shows a second exemplary embodiment.

FIGS. 4a-c show the steps of the method obtained according to an example embodiment of the invention.

FIG. 5 shows a third exemplary embodiment.

FIG. 6 shows a third exemplary embodiment after replacing the cover lens.

### DETAILED DESCRIPTION OF THE DRAWINGS

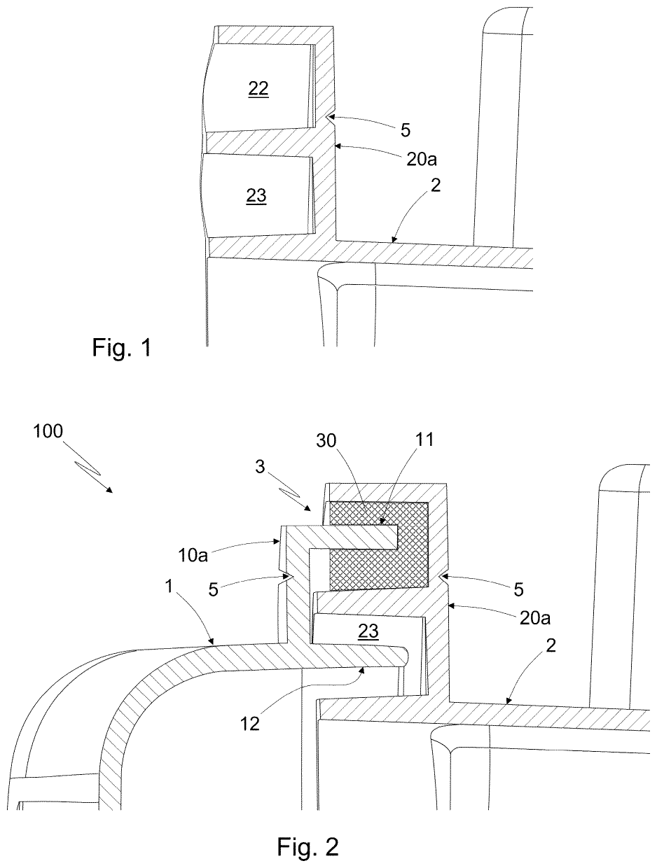

FIG. 1 shows a housing 2 for an attachment assembly obtained with the invention that has a cover lens. The housing 2 has the attachment section 20a with two circumferential channels 22, 23 forming the outer channel 22 and inner channel 23. The outer channel 22 is for the adhesive bed for the first adhesive bond, and the inner channel 23 is for the adhesive bed for the second adhesive bond. The circumferential predetermined breaking point 5 is formed in the bottom of the outer channel 22 to release the first adhesive bond, along which the attachment section 20 can be separated.

FIG. 2 shows a first exemplary embodiment of the attachment assembly 100 formed with the housing 2 shown in FIG. 1, on which a cover lens 1 is placed. The cover lens 1 is attached to the housing 2 with the first adhesive bond 3 with the circumferential adhesive bed 30, which is placed in the outer channel 22. The circumferential collar 11 is formed on the attachment section 10a of the cover lens 1, which then extends into the outer channel 22 and is received in the adhesive bed 30, thus obtaining the first adhesive bond 3. The collar 11 and outer channel 22 that has the adhesive bed 30 encircle the entirety of the cover lens 1 and housing 2 such that the interior of the housing 2 is sealed against the operating environment. The inner channel 23 and collar 12 that extends therein form the means to create a second adhesive bond with a circumferential adhesive bed. By separating the first adhesive bond 3 and removing the cover lens 1 to replace it, the inner channel 23 is exposed and fresh adhesive can be placed therein.

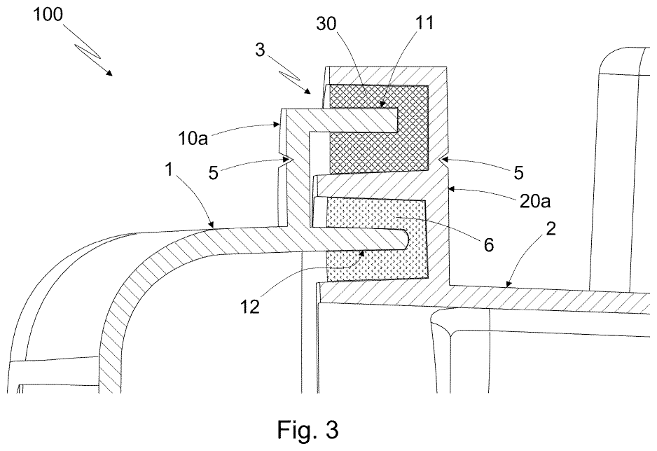

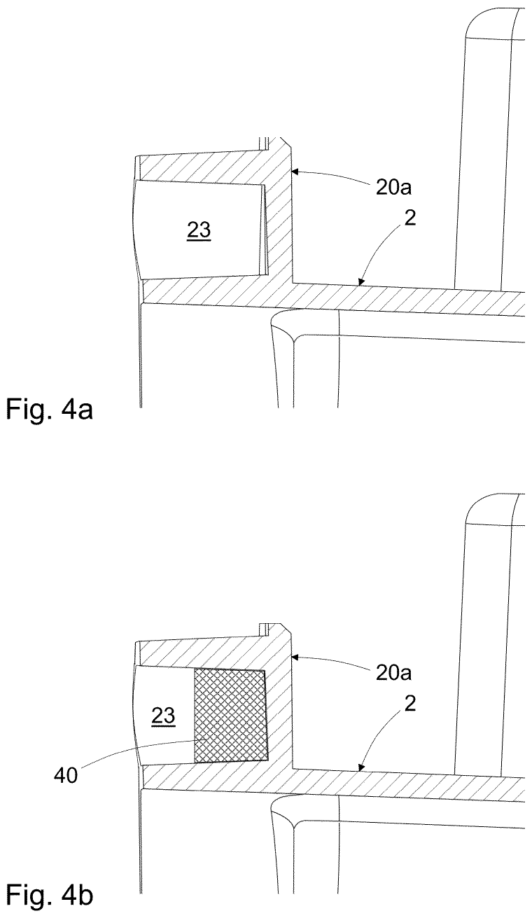

FIG. 3 shows a second exemplary embodiment of the attachment assembly 100, which corresponds to the first exemplary embodiment, shown in FIG. 2, aside from that a supplementary seal 6, e.g. a foam rubber element, is placed in the inner channel 23. In addition to improving the sealing of the interior of the housing 2, the seal 6 keeps the inner channel 23 clean, such that the surface accommodating the adhesive bed for the second adhesive bond is kept clean.

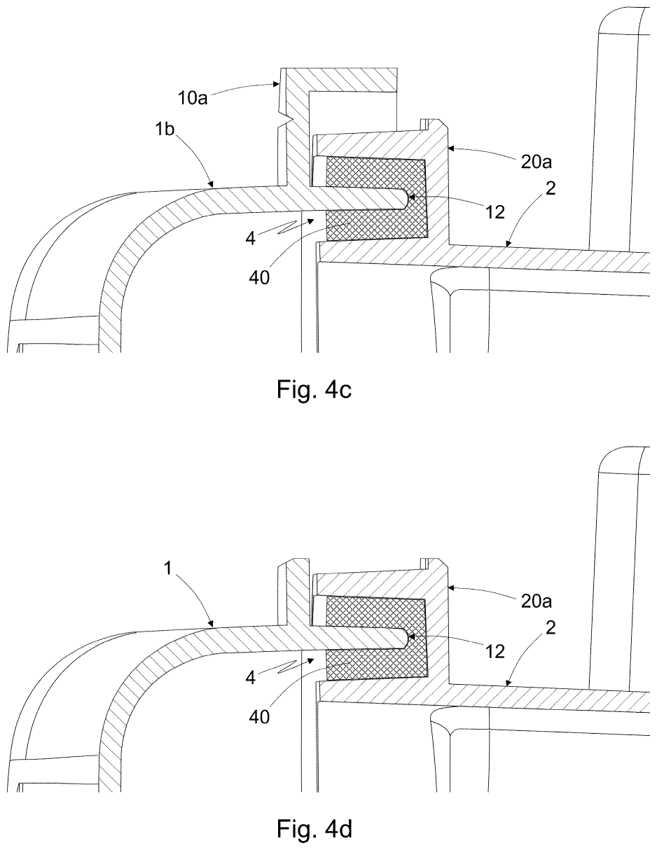

Based on the first and second exemplary embodiments of the attachment assemblies 100, FIG. 4a shows the housing 2 after releasing the first adhesive bond 3 and removing the cover lens 1 that is to be replaced in the first step of the method obtained with the invention. The attachment sections 10a, 20a are separated along the predetermined breaking points 5 to release the first adhesive bond 3, e.g. using a fine angle grinder (“Dremel”) or a similar tool.

FIG. 4b shows the inner channel 23 after placing a circumferential adhesive bed 40 therein. The adhesive used for this preferably corresponds to the original adhesive in the first adhesive bond 3, such that a substantially functionally identical second adhesive bond 4 can be obtained.

FIG. 4c shows a new attachment assembly, after placing the new cover lens 1b on the housing 2, forming a second adhesive bond 4 to the collar 12 in the adhesive bed 40. The new cover lens 1b is a replacement part. It is also possible to use the old cover lens 1 in the new attachment assembly.

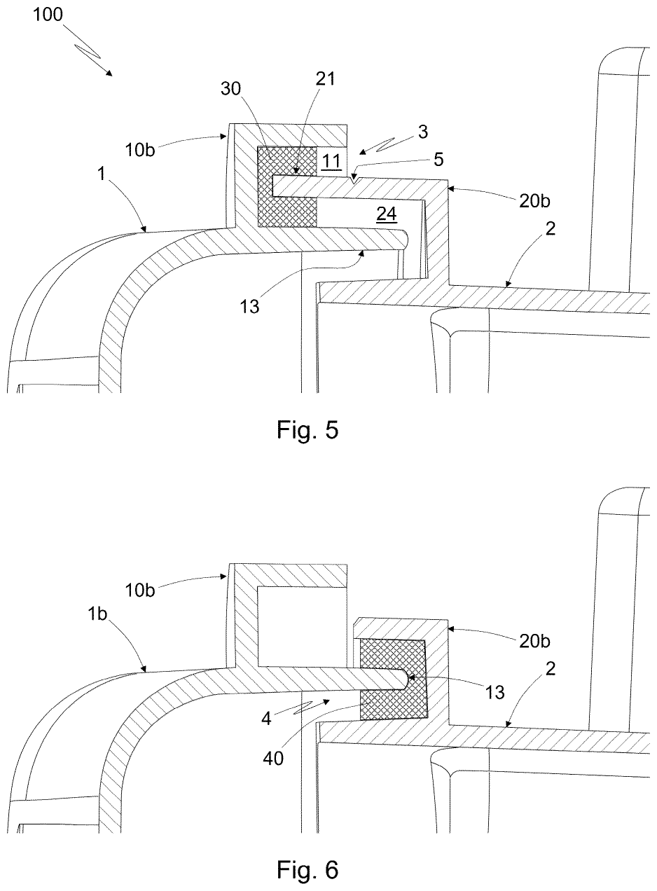

FIG. 5 shows a third exemplary embodiment of the attachment assembly 100 in which the cover lens 1 and housing 2 each have an attachment section 10b, 20b with a circumferential channel 14, 24. These form an outer channel 14 and an inner channel 24, with the adhesive bed 30 for the first adhesive bond 3 being placed in the outer channel 14, and the second adhesive bed being placed in the inner channel 24. The attachment section 20b on the housing 2 comprises the collar 21 that is received in the adhesive bed 30, and the collar 13 in the attachment section 10b extends into the inner channel 24. The circumferential predetermined breaking point 5 is used to release the first adhesive bond 4, along which the attachment section 20b can be separated. The third exemplary embodiment is advantageously compact.

Starting from the third exemplary embodiment of the attachment assembly 100 shown in FIG. 5, FIG. 6 shows the replacement cover lens 1b. After separating the attachment section 20b along the predetermined breaking point 5, the inner channel 24 remains available for the adhesive bed 40 for the second adhesive bond 4.

All of the exemplary embodiments of the attachment assembly 100 shown here are intended in particular for use in a lighting device for a motor vehicle, e.g. a headlamp. The housing is used to contain the light module, and the light exiting the lighting device when in use passes through the cover lens. If it becomes damaged, e.g. by rocks striking it, the cover lens 1 can be easily replaced as a result of the attachment assembly 100 obtained with the invention. This also allows access to the interior of the housing 2 if the light modules, for example, need to be replaced.

### LIST OF REFERENCE SYMBOLS

100 attachment assembly
1, 1b cover lens
10a, 10b attachment section
11, 12, 13 collar
14 outer channel
2 housing
20a, 20b attachment section
21 collar
22 outer channel
23 inner channel
24 inner channel
3 first adhesive bond
30 adhesive bed
4 second adhesive bond
40 adhesive bed
5 predetermined breaking point
6 sealing means

1. An attachment assembly between a cover lens and a housing, the attachment assembly comprising:
a first circumferential adhesive bed and a second circumferential adhesive bed on the cover lens and/or the housing,
wherein the cover lens is attached to the housing by a first adhesive bond via the first circumferential adhesive bed, and
wherein the cover lens or a replacement cover lens is attachable to the housing by a second adhesive bond via the second circumferential adhesive bed.

2. The attachment assembly according to claim 1, wherein the cover lens and/or housing have first and second circumferential collars that are received respectively in the first and second adhesive beds to obtain the first and second adhesive bonds.

3. The attachment assembly according to claim 1, wherein the cover lens or the housing has an attachment section with a first circumferential channel forming an outer channel and a second circumferential channel forming an inner channel, wherein the first adhesive bed for the first adhesive bond is placed in the outer channel, and wherein the second adhesive bed for the second adhesive bond is placed in the inner channel.

4. The attachment assembly according to claim 1, wherein the cover lens and housing each have an attachment section with a circumferential outer channel and a circumferential an inner channel, wherein the first adhesive bed for the first adhesive bond is positioned in the outer channel, and wherein the second adhesive bed for the second adhesive bond is positioned in the inner channel.

5. The attachment assembly according to claim 3, wherein the attachment section has a circumferential predetermined breaking point where the first adhesive bond can be released.

6. The attachment assembly according to claim 3, wherein a seal is placed in the inner channel.

7. A lighting device for a motor vehicle, the lighting device comprising:
a cover lens; and
a housing,
wherein the cover lens and housing form an attachment assembly according to claim 1.

8. A method for replacing the cover lens in an attachment assembly according to claim 1, the method comprising the steps of:
releasing the first adhesive bond and removing the cover lens;
inserting a circumferential adhesive bed; and
placing a new cover lens on the housing to form the second adhesive bond.

9. The method according to claim 8, wherein when releasing the first adhesive bond, the attachment sections are separated along the predetermined breaking points.

10. The attachment assembly according to claim 6, wherein the seal is a foam rubber element.
